(19) United States
(12) Patent Application Publication
(10) Pub. No.: US 2010/0131878 A1
(43) Pub. Date: May 27, 2010

(54) Widgetized Avatar And A Method And System Of Creating And Using Same

(76) Inventor: Robb Fujioka, Manhattan Beach, CA (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(21) Appl. No.: 12/494,940

(22) Filed: Jun. 30, 2009

Related U.S. Application Data
(60) Provisional application No. 61/190,810, filed on Sep. 2, 2008.

(51) Int. Cl. G06F 3/048; G06T 11/20

(52) U.S. Cl. 715/765; 345/441; 715/810

(57) ABSTRACT

A computerized graphical representation system for representing a user of at least two social-interaction web environments is disclosed. The computerized graphical representation includes an avatar associated with a front of the card, an information profile associated with a back of the card and indicative of information related to the user represented by the avatar, and at least one building engine accessible via at least one networked connection. The building engine builds the avatar for the user, and at least one aspect of the build associates one or more portions of the avatar with entry of a related one or more portions of the information profile.

### RELATED APPLICATIONS

This application claims priority to U.S. Provisional Patent Application No. 61/190,810 entitled “Widgetized Avatar and a Method and System of Creating and Using Same” filed Sep. 2, 2008 naming as an inventor Robb Fujioka, the entirety of which is incorporated herein as if set forth in its entirety. This application also claims priority to U.S. patent application Ser. No. 12/381,663 entitled “Widgetized Avatar and a Method and System of Creating and Using Same” filed Mar. 13, 20098 naming as an inventor Robb Fujioka, which application claims priority to U.S. Provisional Patent Application No. 61/069,336 entitled “Widgetized Avatar and a Method and System of Creating and Using Same” filed Mar. 13, 2008 naming as an inventor Robb Fujioka, the entirety of which is incorporated herein as if set forth in its entirety.

### FIELD OF THE INVENTION

The present invention is directed to avatars for use in computing communities and, more particularly, to a widgetized avatar and a method and system of creating and using same.

### BACKGROUND OF THE INVENTION

Many computing and entertainment embodiments allow for a user, player, or viewer to create an “avatar.” An avatar is typically a virtual manifestation of that users “computerized physicality.” However, the prior art typically provides only limited options for a user who wishes to create an avatar, such as limited physical features, clothing, associated information, and the like. As such, a typical avatar allows for only very limited information about a user to be relayed by the avatar. More specifically, the physical characteristics the avatar likely have only limited applicability to the physicality of the real-world user, due in part to the limited physical, clothing and the like options available in creating the avatar, and the typical information associated with the avatar, other than its physicality, is limited or non-existent.

Additionally, present avatars need to be created over and over again, and are highly variable for the same real user as between different applications using an avatar, in principal part because avatars are not typically transferable as between multiple applications. Further, present avatars present little or no monetization or marketing opportunities, nor do present avatars allow for collection of or provision to, potential transaction partners of the preferences, characteristics or interests of the actual user.

Thus, the need exists for an avatar, and an apparatus, system and method related thereto, that allows for transferability, improved physical relation to the actual user, more information regarding the actual user, and improved marketing, monetization and transaction opportunities related to the user's avatar.

### SUMMARY OF THE INVENTION

A computerized graphical representation card for representing a user of at least two social-interaction web environments is disclosed. The computerized graphical representation includes an avatar associated with a front of the card, an information profile associated with a back of the card and indicative of information related to the user represented by the avatar, an icon-based flip for switching between the front and the back, and at least one dialog bubble on the front and proximate to the avatar. The at least one dialog bubble includes at least one indicator.

A computerized graphical representation card for representing a user of at least two social-interaction web environments is disclosed. The computerized graphical representation card includes an avatar associated with a front of the card, an information profile associated with a back of the card and indicative of information related to the user represented by the avatar, and at least one emotion indicator on the front and associated with the avatar. The at least one emotion indicator is indicative of at least one aspect of the information profile.

A computerized graphical representation system for representing a user of at least two social interaction web environments is disclosed. The computerized graphical representation includes an avatar associated with a front of the card, an information profile associated with a back of the card and indicative of information related to the user represented by the avatar, and at least one building engine accessible via at least one networked connection. The building engine builds the avatar for the user, and at least one aspect of the build associates one or more portions of the avatar with entry of a related one or more portions of the information profile.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates an avatar in accordance with the present invention;

FIG. 2 illustrates an avatar in accordance with the present invention;

FIG. 3 illustrates an avatar in accordance with the present invention;

FIG. 4 illustrates a plurality of avatars in accordance with the present invention;

FIG. 5 illustrates a flow diagram in accordance with the present invention; and

FIG. 6 illustrates an avatar/graphical representation in accordance with the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical avatar and computing apparatuses, systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

An avatar is understood by one of ordinary skill in the art to include a computer user's representation of him or herself, such as in the form of a two or three dimensional model used in computer games, social network applications, or other on-line communities. A typical avatar may further include, or have associated therewith, a user's name, a user's screen name, a handle, or text of interest, such as a trademark, saying, or poem, for example.

A widget in accordance with the present invention, and as will be understood by one of ordinary skill in the art, is a portable portion of code that may be installed or executed within any separate HTML based webpage by an end user without necessitating additional compilation of that code portion. Such widget code portions, in accordance with the present invention, are embeddable by the end user. As such, a widget in accordance with the present invention is any code portion that may be embedded by the end user within a selected page of HTML, XML, or like code that causes presentation of that selected web page. The widget, via the embedded code portion, thereby adds non-static content to the subject webpage.

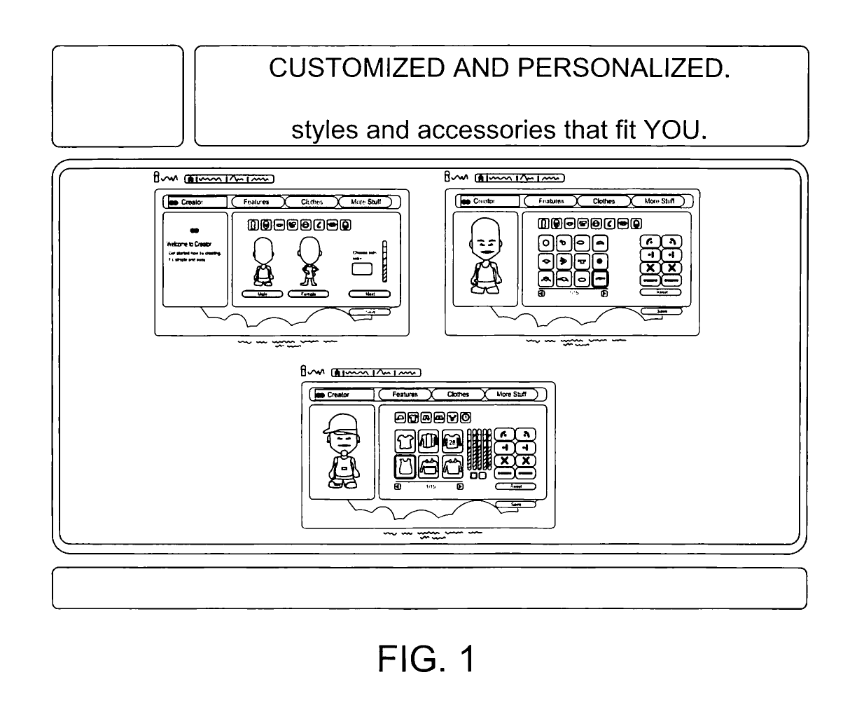

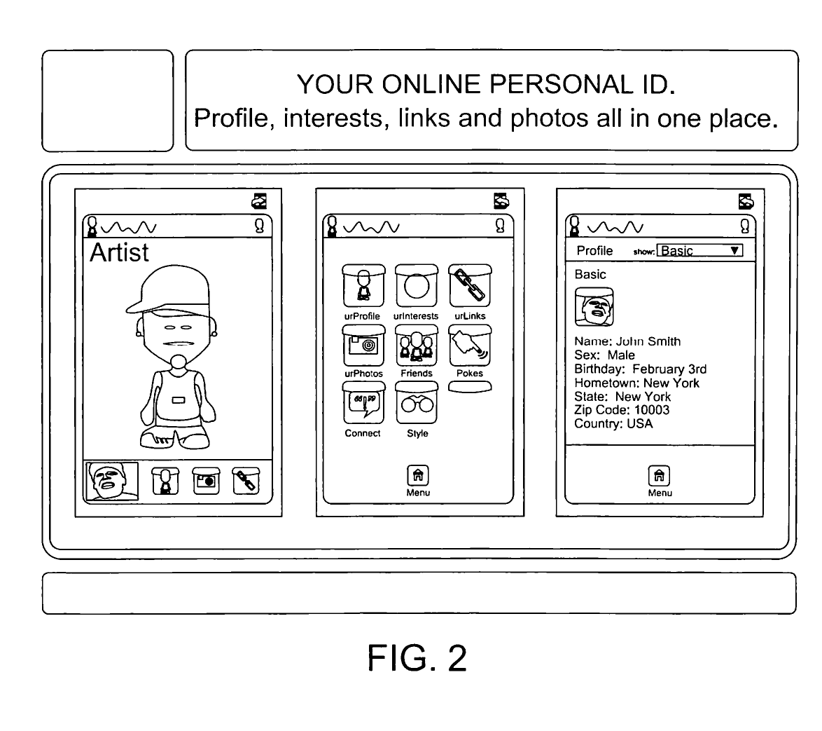

The present invention includes a fully portable, widgetized avatar having associated therewith multiple items of social information that are generally requested for association with at least two different computing communities or transactions. Widgetization of the avatar of the present invention necessarily allows for portability of the avatar of the present invention. For example, creation of a typical avatar in accordance with the present invention may include the association of physical features, such as facial and hair, with the subject avatar, as well as the aforementioned user name, as shown in FIG. 1. Further, a myriad of additional information may be associated with the avatar, wherein such information is generally required or desired for use in computing communities or transactions. This information may be organized into multiple levels of detail, and/or multiple levels of accessibility to third parties in a computing community or transaction. Such levels of accessibility may be selected by the creator of the widgetized avatar based on characteristics of the third party endeavoring to access the subject avatar. For example, a user may have basic information, which may be selectable for viewing by all registered users of a particular community, as shown in FIG. 2.

In an exemplary embodiment, a user may have likes or dislikes, such as musical or motion picture tastes, job or educational status, age, location, income, marital status, and other computed communities with which that user is associated, associated with his or her avatar. The present invention provides a physical manifestation of all of this information, such as in a “trading card” format. For example, FIG. 2 illustrates an avatar wherein the front of the virtual trading card includes an avatar having particular physical features, clothing, accessories, activities, and the like, along with an associated user name. However, when an interaction, such as selection of a drop-down menu, selection of a link, a double click, or the like is undertaken to “flip” a trading card to the back, a myriad of additional information is displayed regarding the user related to the widgetized avatar, such as age, interests, likes and dislikes, employment status, and the like.

Needless to say, because the virtual manifestation of the physical trading card is embodied in the computing code that provides for the virtual manifestation, such computing code may be provided in such a normalized format that it is easily adopted into multiple computing communities, and/or may be adopted as non-static content onto multiple different web pages. As such, the subject avatar may be incorporated into multiple social communities, fantasy sports communities, blogs, and the like. Further, avatars of particular interest to the general public, such as trading card avatars of musical artists or other famous persons, may be downloaded or referenced by fans of such famous persons. Such avatars may, in fact, be presented in non-classical formats, such as through a tab presentation on a web page designed by the user as a home page in a certain community, or that is set forth by a particular computing community. Such “celebrity” avatars, including in such non-classical formats, may include presentations or allow for interactions with celebrity suggestions or favorites, such as recipes, music, concerts, movies, talk shows, reality shows, or the like, and may further allow for purchases from or related to such suggestions or favorites.

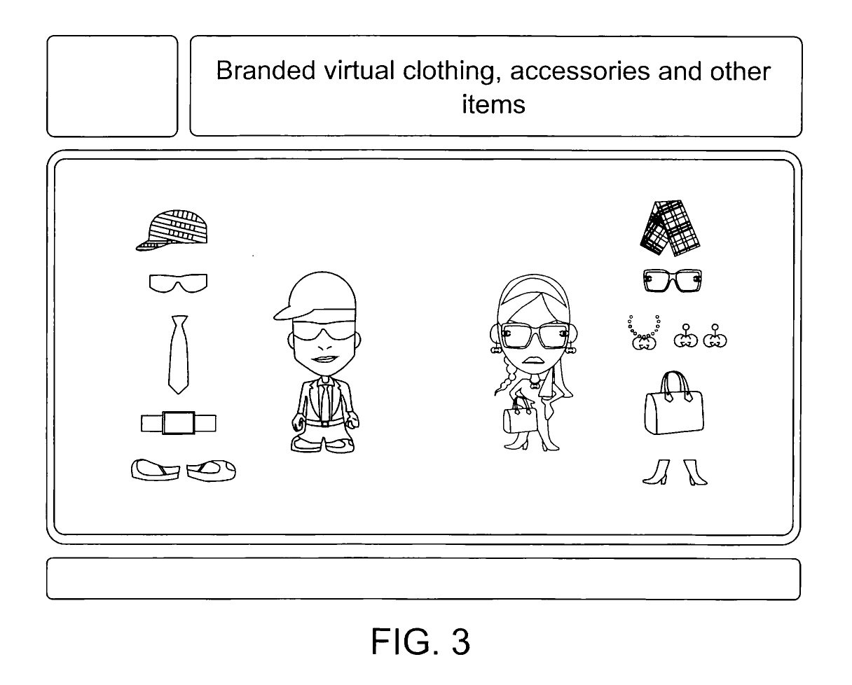

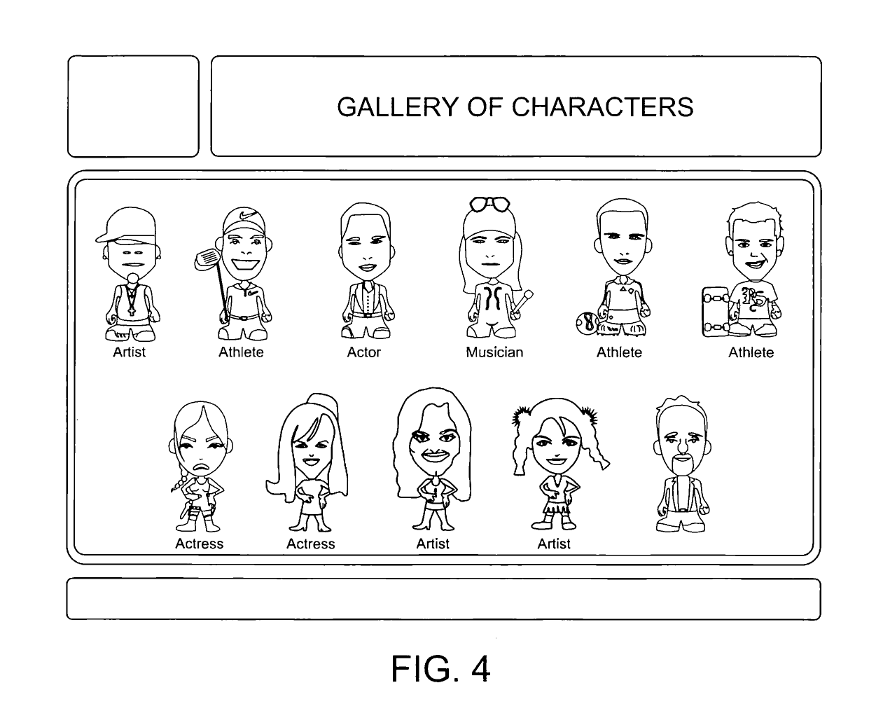

As referenced hereinabove, a typical avatar may have associated therewith certain physical features, clothing, accessories or activities. As such, the present invention is and includes a tool whereby such physical features, clothing, accessories, and activities may be taken from the real world and “virtualized,” for use with a subject avatar, as shown in FIG. 3. For example, famous clothing lines, such as Vera Wang clothing, or famous shoe lines, such as Nike sneakers, or famous accessories, such as Kate Spade purses, or well known activities, such as playing for the Philadelphia Phillies, may be virtualized for use with an avatar. As such, virtualized items may be made available for sale for use with an avatar just as the corresponding real items are generally for sale for use with the real world user correspondent to the avatar. Likewise, celebrity avatars may be presented as “model” widgetized avatars, and the user may be enabled to purchase those items worn by the celebrity's avatar, and/or that are endorsed by that celebrity, as shown in FIG. 4.

Thereby, for example, during creation of a discreet widgetized avatar and/or a widgetized avatar to be associated with the aforementioned avatar trading card, the user creating the avatar may have available a selectable library of options for association with the subject avatar, such as a searchable library of options searchable by key word, or a hierarchal library of options presented by topic. For example, under “fashion”, a user may be presented with available virtual clothing lines for the avatar by piece of clothing. For example, under “shirts”, the user may be presented with options such as Jones New York, Tommy Hilfiger, Fubu, Major League Baseball, National Football League, and the like. The user may then select one of the presented fashion topics for shirts, and then may be presented with the entire line of “real world” shirts associated with that fashion line, but, of course in a virtualized format. Thus, for example, upon selection of Major League Baseball, the user may be presented with a series of major league baseball team jerseys for association with that user's avatar. Needless to say, the user may then select the baseball jersey of that user's favorite team, and may in fact pay for the use of that virtual jersey just as the user might pay for the purchase of a real world jersey of that user's favorite baseball tear Similarly, fashion lines of pants, dresses, suits, shoes, and the like may be made available for use with avatars, and may in fact be made available for purchase by users for use with avatars. Likewise, accessories or activities that would require purchase in the real world by the user may additionally allow for purchase of such accessories or activities in the virtual world for use with the user's widgetized avatar.

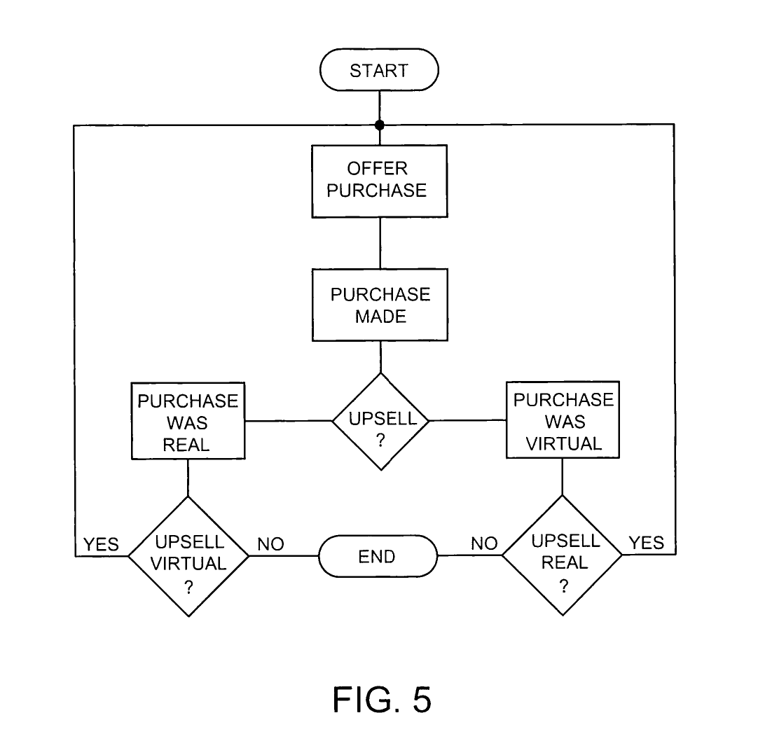

Additionally, the present invention may provide an upsell engine as illustrated in FIG. 5. The upsell engine may operate, upon purchase of a virtual item for association with the user's avatar, may present the user with an opportunity to purchase the same or similar article in the real world for real world use by the actual user based on that user's known preference for that article as evidenced by the purchase of the virtual article for use with the user's avatar. The upsell engine may additionally or alternatively include presentation to the user of an advertisement for real world articles that are the same as or associated with the virtual article purchased by the user, or may allow for presentation of advertising related to likely related virtual or real world articles of interest to the user based on the user's expressed preference for the particular virtual article selected. Needless to say, the present invention may also be used to upsell in the inverse situation—that is, the situation in which the user purchases a real world article from a particular web site, or surfs a particular web site for real world goods and/or services, may cause the user to be presented with advertising for the purchase of the same or similar virtual articles, or associated or related virtual articles, or to be presented with a direct opportunity to purchase the same, similar, or related virtual articles at the point of purchase of the particular real world article.

Similarly, games, rewards, or the like may be made available to, or via, the aforementioned avatars. For example, when certain objectives are achieved, such as in a gaming community, or based on criteria set forth by a parent with regard to homework, or based on a tracked number of interactions with others in a social circle within a computing community (such interactions need not be online, and need only be capable of being tracked), certain actions or gifts may be made available to or for use with a subject widgetized avatar. For example, 3 members of a social community may decide to form an avatar rock band, whereby, the more those 3 members communicate via email, instant message, SMS text, or the like, over a week, the better each member's avatar will play in a weekend “jam session,” Likewise, if an avatar corresponds to a person who makes a certain number of music purchases in a week, or a month, or in any predetermined time frame, the correspondent avatar may be enabled to dance with a certain popular musical artist, or dance as a certain popular musical artist in front of a concert crowd, for example. Other examples include, without limitation, allowing an avatar to play a sport, such as soccer, drive a car, such as a Ferrari, or accumulate points toward advancement in a game, or towards making purchases online.

Further, the present invention may allow for association of particular levels of expertise with particular areas of interest as related to the avatar trading card. As such, the user associated with the subject avatar may take a rating of that user's expertise in certain areas from computing community to computing community. Thus, searches may be made available in one or more computing communities for persons having desired levels of expertise in certain areas. The user may thus accumulate expertise points in multiple computing communities at the same time, wherein such points may be associated with that user's transferable widgetized avatar, whereby a user's expertise may rise based on accumulated expertise points. Additionally and alternatively, a user's expertise in a certain area may increase based on feedback from other users in one or more computing communities in relation to the subject users expertise in a particular area, or a user's expertise may increase based on an assignment of expertise levels by one or more of the computing communities, or a user's expertise level may rise based on advice offered, amount of advice offered, or purchase of expertise or advice from that user in or more on-line computing communities. Thus, a search by a party in need, such as a key word search, for an expert in a particular area and may not return a user advertising to be an expert in a particular area, but instead may return a user adjudged to be an expert in a particular area by parties other than that user him or himself. Of course, in accordance with the present invention, such expertise levels may be associated with the avatar or avatar trading card, and as such may be subsequently transferred to other computing communities.

Thus, the avatar of the present invention enables a user to create a portable, fully virtual “person” for association with that user and carrying the characteristics of that user, including a personal profile and identification card that can be used in combination with any web page, webtop or desktop and any computing community, transaction or social networking situation. Thereby, the avatar of the present invention allows users to connect with other users and share ideas, content, expertise, and applications. Further, the avatar of the present invention thus assists in viral growth by offering users of certain or multiple computing communities an avatar that keeps all personal profile information in one transportable place. Additionally, the avatars of the present invention may provide a foundation for a recommendation and expertise engine employing an algorithm that may suggest content or an expert based on a user's community, popularity, known expertise, clicks, interests, searches, or the like.

Thus, the avatar of the present invention may include one or more of the user profile, physicality of avatar, user personal characteristics, user interests, user links, user photos, videos, or audio, user friends, user sayings, jokes, or the like, user notes, connections or message postings, and user clothing, accessories, activities and general style. As used herein, the computing communities and transactions to which the avatar of the present invention may be transferred include all computing communities, including telecommunications communities such as those accessible from cellular telephones, televisions, and the like.

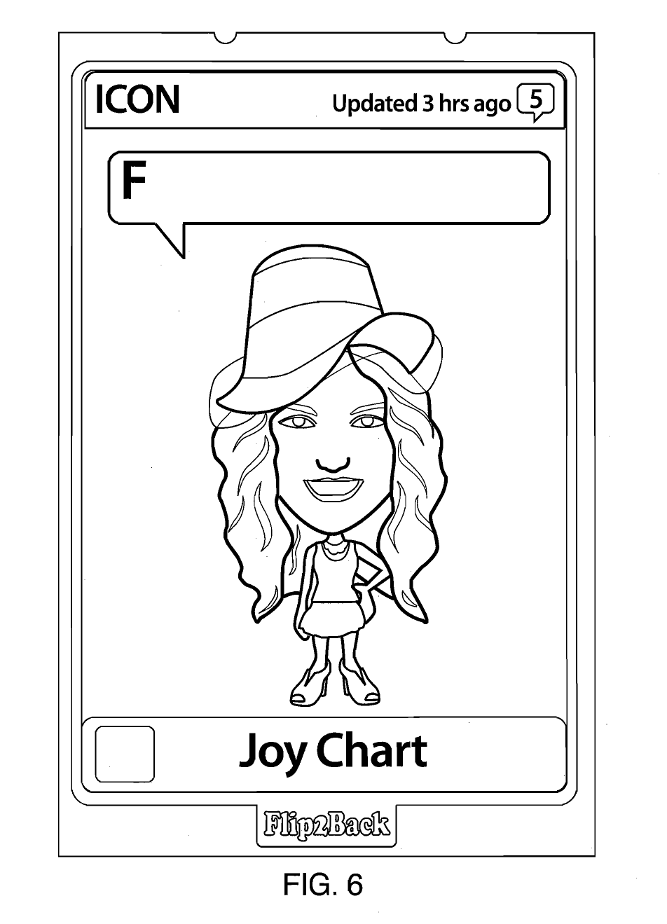

FIG. 6 illustrates an avatar/graphical representation in accordance with the present invention. As discussed hereinthroughout, the avatar may be presented in a trading card format, such as wherein a graphical representation of the user, or of a famous or otherwise well known person, may be presented on the “front” of the card, and information related to the subject of the graphical representation, such as personal information or statistics, likes, dislikes, hobbies, memberships, affiliations, social networking activity, or the like, may be presented on the back of the trading card. The trading card may be electronically “flipped” via any known means, such as through the provision of a button or tab that, upon clicking, “flips” the card. Further, the avatar of the present invention may, as discussed hereinabove, be widgetized and/or may other wise be portable as between at least two web-based environments, such as social networks.

As illustrated in FIG. 6, the graphical representation may have associated therewith a thought or dialog bubble. Such a dialog bubble may be of any size or shape, and in preferred embodiments may not obscure the graphical representation to which it related. The dialog bubble may be placed in any position proximate to the graphical representation. The dialog bubble may provide text, such as entered by the user, such as regarding the user's thoughts, moods, notes, memories, desires, activities, opinions, interests (or information related thereto, such as sports scores) and the like, or such as entered by a third party, such as regarding the third party's information related to the user, and/or the user's moods, interests, activities, etc. as assessed or viewed by the third party. The text may scroll, be static, or be subjected to like actions or transformations, as will be apparent to those skilled in the art. Similarly, the dialog bubble may provide data in those manners referenced hereinabove with respect to text. As will be understood by those skilled in the art, the aforementioned text and/or data, in any combination, may be automatically provided, such as in the event of a particular trigger (which trigger may be assessed via the internet, such as via a web crawl or spider implemented to detect an announcement of a certain occurrence), or may be manually entered. Further, the text and/or data may be available and/or entered and/or accessed locally, or from a remote point.

Additionally and/or alternatively, the dialog bubble may include icons related to the user's activities, thoughts, moods, memories, desires, and the like. For example, the thought bubble may include icons of all social networks on which the subject user is active, wherein a third party may be linked to that user's social network page by clicking the subject icon. Similarly, the social networks of that user may appear in that user's dialog bubble when those social networks include updates, such as new information, notes, or pictures, for example. Alternatively, all icons in a certain category, such as social networks, may be displayed, but may be modified when associated with updates, such as wherein all icons are gray in color, but those including updates are in color, for example. Likewise, such icons may be indicative of user generated content, and/or designed by one or more users. Such icons may scroll, be static, or the like, within the dialog bubble, as will be understood by those skilled in the art.

Further, such icons may indicate the moods or emotions of the user. For example, a circular or substantially circular character may reside within the thought bubble, and a smile on that character may indicate that the user associated with the graphical representation is in a good mood, or is happy. Additionally, in certain embodiments, a user may add text to the thought bubble, or icons or similar links to social networking sites, in which the user may indicate the reasons for such happiness. Of course, emotions thus displayed through the use of the present invention may include happiness, sadness, anger, jealousy, or other emotions known to those skilled in the art.

Additionally and alternatively, the emoting icon in the dialog bubble may be a miniaturized version of the graphical representation, and the emotion to be conveyed may be indicated by variations in the graphical representation's facial expectations. Such modifications may be automatically selected, such as wherein any avatar having selected therefore choice #5 as a typical mouth expression is automatically modified to having mouth choice #9 when the user indicates happiness, or may be manually input by the user, either during setup of the subject avatar or at a subsequent time, such as by the user selecting mouth choice #9 responsive to “use this mouth when I am happy.” Likewise, facial feature modifications based on an input mood or emotion may include eyes, forehead, nose, chin, etc.

Further, as will be understood by those skilled in the art in light of the discussion herein, the graphical representation itself may be modified, based on a selected emotion, and the dialog bubble may provide a means of conveying the reason for the emotion displayed by the avatar. Further, in such embodiments, the entire avatar, such as including body position/stance, position of extremities, and the like, may be manually or automatically selected as modified in the event of an entered emotion,

The present invention may be employed to “build” an avatar, and/or a trading card for association therewith. A standard methodology of such building includes allowing a user to select on or more bodies, extremities, clothing or accessories, environments, actions, and facial features, such as hair, eyes, eyebrows, forehead, nose, ears, cheeks, chin, and mouth, for example. Multiple options may be provided for one, more than one, or all of the aforementioned selections. The present invention may additionally include a suggestion engine that may recommend one or more of the selectable options for use on the avatar, such as in accordance with a downloaded picture (such as by using multipoint facial approximations), or in accordance with interests (i.e. a Lakers jersey may be recommended in the event the builder of the avatar enters an interest in the Lakers).

With regard to building information for association with the “back” of the trading card, an exemplary standard methodology might include asking a user to fill out a user profile by responding to one or more consecutive profile questions. The present invention may advantageously provide, rather than asking a user to fill out a standard profile, questions associated with the selection of one or more aspects of the avatar. For example, when a user enters a screen to select the eyes of the user's avatar, the user may be asked one or more questions related to that user's preferred visual stimulants. For example, a user may be asked to enter a favorite movie, television show, or newspaper, i.e. things the actual user “views,” at selection of the eyes for association with that user's avatar. Likewise, a user may be asked what type of exercise the user prefers while selecting the body of the avatar, or what sports teams the user is a fan of upon selection of the clothing for the user's avatar, or a favorite song upon selection of the subject avatar's ears. Additionally and alternatively, the user may be given options, such as via drop down menus, of available profile aspects related to each screen displayed during generation of an avatar. For example, a user may select from movies, television, and newspaper while selecting the eyes of the avatar, and may then, upon selection of movies, for example, be enabled to enter text, or be provided with additional dropdowns, such as classic movies, 80's movies, 90's movies, 00's movies, or in theaters, for example.

Further, the information that fills the user profile may be any of a variety of information, certain of which information may not preferably be made publicly available in one or more of the aforementioned environments into which the subject avatar may be incorporated. For example, the present invention may, such as via metadata, assess one or more aspects and/or purposes of one or more web environments. Upon placement of the avatar into each such web environment, automatically, and/or responsive to user instructions placed within such profile, the present invention may modify, remove from, or add to the profile information available in each such respective environment. More specifically, a user's marital status and/or preferences in a significant other may be made available on the back of a trading card when the avatar is transported to a dating site, but may be hidden, blocked, or otherwise removed when the avatar is transported to an employment networking site.

Additionally, such profile information may be used to fill out a user's profile, but may also be used for marketing or advertising purposes. For example, selection by entry of text, or from a dropdown menu, of a favorite movie may cause the display to the user, during the current session, of an advertisement for the release of the subject movie on DVD. Additionally, in the example hereinabove with respect to picking a favorite movie release still in theaters, the present invention may allow real time monitoring of current movie viewership, repeat viewers, and/or reviews.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

We claim:

1. A computerized graphical representation card for representing a user of at least two social-interaction web environments, comprising:
an avatar associated with a front of the card;
an information profile associated with a back of the card and indicative of information related to the user represented by said avatar;
an icon-based flip for switching between the front and the back; and
at least one dialog bubble on the front and proximate to said avatar, wherein said at least one dialog bubble comprises at least one indicator.

2. The computerized graphical representation card of claim 1, wherein said at least one dialog bubble comprises at least one of a predetermined size and shape.

3. The computerized graphical representation card of claim 1, wherein the indicator comprises text.

4. The computerized graphical representation card of claim 1, wherein the indicator indicates at least one selected from the group consisting of thoughts, moods, notes, memories, desires, activities, opinions, interests, and a third party assessment.

5. The computerized graphical representation card of claim 1, wherein the indicator graphically scrolls.

6. The computerized graphical representation card of claim 1, wherein the indicator is graphically static.

7. The computerized graphical representation card of claim 1, wherein the indicator comprises data,

8. The computerized graphical representation card of claim 1, wherein the indicator is provided responsive to at least one trigger.

9. The computerized graphical representation card of claim 8, wherein the at least one trigger is manually entered.

10. The computerized graphical representation card of claim 8, wherein the at least one trigger emanates remotely.

11. The computerized graphical representation card of claim 1, wherein the indicator comprises at least one icon.

12. The computerized graphical representation card of claim 11, wherein the at least one icon is indicative of at least one social network.

13. The computerized graphical representation card of claim 12, wherein an accessing of the at least one icon redirects to the at least one social network.

14. The computerized graphical representation card of claim 12, wherein the indicator comprises an indication of at least one modification in the at least one social network.

15. The computerized graphical representation card of claim 1, wherein the indicator comprises a miniaturized one of said avatar.

16. The computerized graphical representation card of claim 1, wherein the indicator comprises at least two of text, data, and at least one icon.

17. The computerized graphical representation card of claim 1, wherein at least one aspect of said information profile is at least one of added, modified and removed based on an associated one of the at least two social interaction web environments.

18. A computerized graphical representation card for representing a user of at least two social-interaction web environments, comprising:
an avatar associated with a front of the card;
an information profile associated with a back of the card and indicative of information related to the user represented by said avatar; and
at least one emotion indicator on the front and associated with said avatar, wherein said at least one emotion indicator is indicative of at least one aspect of said information profile.

19. The computerized graphical representation card of claim 18, wherein said indicator comprises a miniaturized one of said avatar.

20. The computerized graphical representation card of claim 18, wherein said indicator comprises a cartoon face.

21. The computerized graphical representation card of claim 18, wherein said emotion indicator comprises a modification to at least one facial aspect of said avatar.

22. The computerized graphical representation card of claim 21, wherein the modification is automatically selected.

23. The computerized graphical representation card of claim 21, wherein the modification is manually selected by the user.

24. The computerized graphical representation card of claim 23, wherein the manual selection is predetermined by the user.

25. The computerized graphical representation card of claim 18, wherein said emotion indicator comprises a modification to at least one bodily aspect of said avatar.

26. The computerized graphical representation card of claim 18, wherein said emotion indicator comprises a modification to at least one clothing aspect of said avatar,

27. The computerized graphical representation card of claim 18, wherein said emotion indicator comprises a graphical aspect, and at least one explanatory aspect of the emotion,

28. The computerized graphical representation card of claim 27, wherein the at least one explanatory aspect comprises at least one of text and data.

29. A computerized graphical representation system for representing a user of at least two social-interaction web environments, comprising:
an avatar associated with a front of the card;
an information profile associated with a back of the card and indicative of formation related to the user represented by said avatar; and
at least one building engine accessible via at least one networked connection, wherein said building engine builds said avatar for the user, and wherein at least one aspect of the build associates one or more portions of said avatar with entry of a related one or more portions of said information profile.

30. The computerized graphical representation system of claim 29, wherein said building engine comprises a suggestion engine that recommends one or more selectable ones of the portions of said avatar.

31. The computerized graphical representation system of claim 30, wherein at least one of the recommendations is in accordance with a related one of said information profile.
